(19) United States
(12) Patent Application Publication
(10) Pub. No.: US 2013/0066832 A1
(43) Pub. Date: Mar. 14, 2013

(54) APPLICATION STATE SYNCHRONIZATION

(71) Applicants: John Michael Sheehan, Sammamish, WA (US); Christopher D. Russell, Duvall, WA (US); Hari Krishna Pammi, Redmond, WA (US)

(72) Inventors: John Michael Sheehan, Sammamish, WA (US); Christopher D. Russell, Duvall, WA (US); Hari Krishna Pammi, Redmond, WA (US)

(73) Assignee: Microsoft Corporation, Redmond, WA (US)

(21) Appl. No.: 13/230,267

(22) Filed: Sep. 12, 2011

(51) Int. Cl. G06F 7/00

(52) U.S. Cl. 707/634; 707/E17.005; 707/E17.032

(57) ABSTRACT

One or more techniques and/or systems are provided for synchronizing application state between one or more instances of an application on one or more devices. In particular, an application state, such as application settings, may be synchronized between a first instance of an application on a first device and a second instance of the application on a second device. For example, a user may configure a new email account within a first instance of an email application on a laptop device. The new email account may be synchronized with a second instance of the email application on a tablet device. During synchronization, various conflict resolution, version verifications, and/or consistency verifications may be performed. In this way, the user may be provided with a seamless and consistent experience between the laptop and tablet device.

### BACKGROUND

Today, many users own multiple computing devices, such as desktop devices, laptop devices, smart phones, tablet devices, etc. In addition, such users may utilize multiple instances of an application on various computing devices (e.g., instances of an email application may be loaded onto a laptop device, smart phone, and tablet device of a user). In this way, a user may have access to applications and/or application data on multiple devices (e.g., a user may check an email account on a tablet device while at home, and then later check the email account on a smart phone while on the go). Many conventional applications may have customized application data synchronization functionality. In one example, a first instance of a music library application on a desktop device may comprise customized synchronization functionality to synchronize a user's music file library from the desktop device to a second instance of the music library application on a smart phone. In another example, an application may perform online synchronization of live web data (e.g., a browser-based and/or web server client application), which may be simple to implement in comparison with local storage data synchronization techniques, but may sacrifice performance while online and/or may preclude offline synchronization scenarios. Unfortunately, conventional synchronization functionality may be tailored for and/or built into a specific application. Additionally, conventional synchronization functionality may not be capable of implementing local storage data synchronization with offline capabilities due to complexity and/or cost, and thus application data, such as application settings, may not be adequately synchronized (e.g., an email notification setting, an email view setting, a user configured email account, etc. may not be synchronized). Thus, a user may have to individually configure instances of an application on various devices (e.g., a user may configure an email account within a first instance of an email application on a first device, and may additionally have to separately configure the email account within a second instance of the email application on a second device).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for synchronizing an application state are disclosed herein. That is, in one example, local application data associated with an application (e.g., application files and/or settings stored on a locally-attached storage device) may be synchronized (e.g., through a cloud network) with remote endpoints (e.g., additional computing devices) comprising instances of the application. It may be appreciated that an application may be loaded onto a computing device as an instance of the application (e.g., a first instance of an email application may be loaded onto a smart phone, a second instance of the email application may be loaded onto a laptop device, etc.). An instance of an application may be associated with an application state. The application state may comprise application data, such as application files and/or settings, associated with the instance of the application. For example, an application state (e.g., hierarchical information within a configuration file, settings stored in an XML file, settings stored within an operating system registry, settings stored in a database, etc.) for an instance of an email application on a laptop device may comprise email account settings (e.g., user name, password, and email provider), application settings (e.g., user preferences as to how email is to be retrieved, delivered, and/or displayed), and/or a variety of other information associated with the email application. It may be advantageous to synchronize the application state of the instance of the email application on the laptop device with a second instance of the email application on a second device, such as a smart phone. In this way, the email settings of the second instance of the email application on the smart phone may be synchronized with the email settings of the first instance of the email application on the laptop device in order to provide a user with a seamless transition between using instances of the email application on the laptop device and on the smart phone (e.g., settings, such as email accounts and/or user preferences, of the email application may be synchronized/mirrored between the devices).

Accordingly, application state may be synchronized between a first instance of an application on a first device and a second instance of the application on a second device. It may be appreciated that one example of an application state 702 is illustrated in FIG. 7. It may be appreciated that application state may be synchronized between a plurality of instances of the application on various devices. In one example, a modification to a first application state of a first instance of an application on a first device may be detected. The modification may result in a modified first application state for the first instance for the application. For example, a user may add a new email account to a first instance of an email application. New email account settings may be saved within a first application state to create a modified first application state (e.g., the new email account settings may be saved to an application settings file). A first application state update (e.g., synchronization data and/or instructions) corresponding to the modified first application state may be sent to a synchronization component for synchronizing a second application state of a second instance of the application on a second device, resulting in a synchronized second application state. For example, the first application state update may be utilized by the second device to update the second application state with the new email account settings. In this way, the new email account settings may be synchronized between the first device and the second device. It may be appreciated that “first”, “second”, etc. are merely used herein as identifiers and are not intended to imply an ordering, etc., unless specified as so intending.

In another example, a second application state update (e.g., synchronization data and/or instructions) corresponding to a modification to the synchronized second application state of the second instance of the application on the second device may be received from the synchronization component (e.g., the first device may receive the second application state update). For example, the password of the new email account settings may have been modified at the second device. The modified first application state may (on the first device) be updated using the second application state update to create a synchronized third application state (e.g., the modified first application state on the first device is synchronized with the new password). In this way, the new password may be synchronized between the second device and the first device.

When synchronizing application state, conflict resolution, version verification, and/or consistency verification may be performed. In one example, an application state may be assigned a schema version. The schema version may correspond to a version associated with a schema format according to which the application state may be stored (e.g., the schema format may specify a hierarchical format defining how and/or what application settings may be stored within an application state, such as an XML configuration file). For example, an application state of an email application may be formatted according to a first schema format that may specify that a connecting setting is to comprise two separate fields, such as a connection string field and a separate port number field. The first schema format may be updated to a second schema format (e.g., an update may be applied to the email application), such that the connection setting is to comprise a single field, such as a connection field within which both the connection string and the port number may be specified as a single entry. When updating the application state with an application state update, schema version checking may be performed so that the application state is not updated into a format unrecognizable by the application (e.g., the email application may expect to read a connection setting comprising two fields (e.g., the connection string field and the port number field), but may error if a connection setting comprising one field (e.g., a connection field) is encountered because the email application may not comprise functionality to correctly process such unexpected information).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of synchronizing application state.

FIG. 2 is a flow chart illustrating an exemplary method of synchronizing application state.

FIG. 3 is a component block diagram illustrating an exemplary system for synchronizing application state.

FIG. 4 is an illustration of an example of synchronizing a second application state of an email application (a second instance of an email application) on a desktop device (a second device) to create a synchronized second application state.

FIG. 5 is an illustration of an example of synchronizing a mail account logical grouping within a second application state of an email application (a second instance of an email application) on a desktop device (a second device) to create a synchronized second application state.

FIG. 6 is an illustration of an example of refraining from synchronizing a second application state of an email application (a second instance of an email application) on a desktop device (a second device) based upon a detected schema version inconsistency.

FIG. 7 is an illustration of an example of an application state.

FIG. 8 is an illustration of an exemplary computer-readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Synchronization and network sharing may allow users to share data between various devices. In one example, a shared folder may allow a user to access files within the shared folder from one or more networked devices, such as a laptop, a desktop, and/or tablet device. The shared folder may be implemented as a simple low-cost synchronization technique. However, the shared folder may not support offline synchronization and/or may not scale with high-performance scenarios, such as multiple instances of an application concurrently synchronizing application data. In another example, a user may synchronize music files between a music player device and a desktop device using a music management application. Such synchronization may be suitable for scenarios where data may be read often, but seldom written, such as photo and/or music file synchronization. In contrast, synchronization of application data associated with an application may be more complex due to the frequent access and/or modification of such application data by instances of the application on various devices during online and/or offline scenarios. Unfortunately, current synchronization techniques may be inflexible because such techniques may be application specific, which may involve domain specific knowledge of the applications being synchronized (e.g., custom code embedded within an application). Additionally, many synchronization techniques may not synchronize settings between applications (e.g., a first instance of an email application may not synchronize a newly configured email account and/or user email viewing preferences with a second instance of the email application). That is, the limitations of conventional synchronization techniques (e.g., online only synchronization, infrequently written data synchronization, shared folder, etc.) may not scale appropriately to accommodate for online/offline synchronization and/or may not afford performance characteristics needed to support synchronization of high-value application data instances, such as application settings, for example.

Accordingly, one or more systems and/or techniques for synchronizing application state (e.g., application data and/or configuration settings of an application) are provided herein. In particular, synchronization may be device and/or application agnostic, such that synchronization may be performed without specific knowledge of an application and/or device. An application may be enrolled for synchronization by merely exposing application state data (e.g., an application may merely store configuration settings within a particular state store, such as a synchronization folder). Application state may be partitioned on a per-user basis, per-application basis, per-version basis, and/or per-product distribution unit basis (e.g., an application package). Various conflict resolution, version verification, and/or consistency verification may be performed during synchronization (e.g., configuration settings formatted according to a particular schema may not be overwritten by configuration settings formatted according to a different schema). In this way, application state of an application may be synchronized safely between various instances of the application on one or more computing devices (e.g., such that different versions of an application with potentially different storage schema requirements may peacefully co-exist with little to no data corruption).

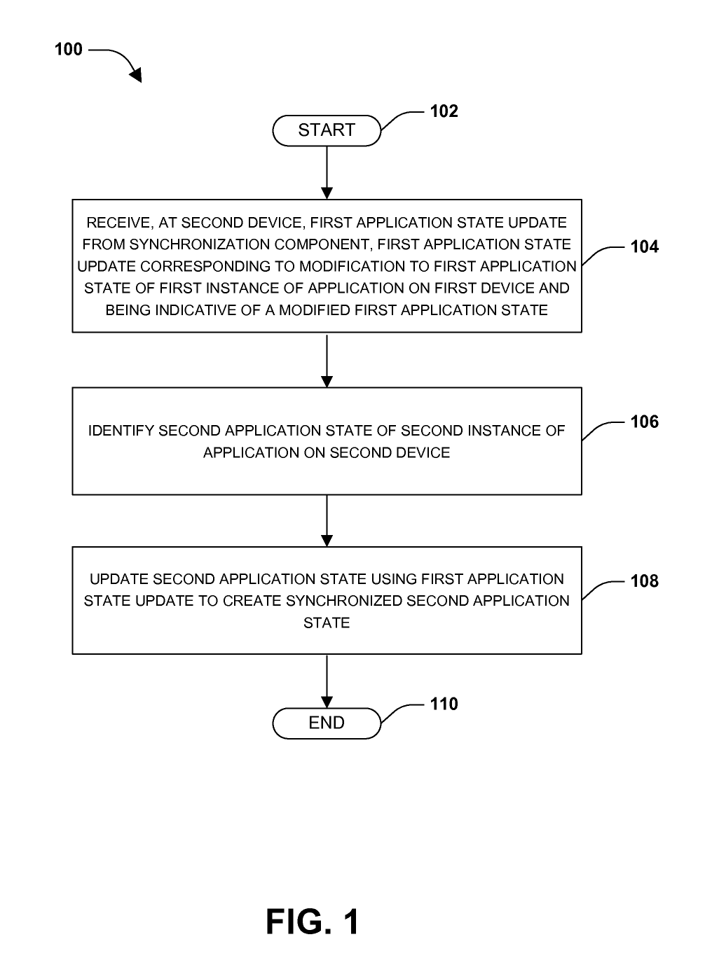

One embodiment of synchronizing application state is illustrated by an exemplary method 100 in FIG. 1. At 102, the method starts. In one example, an application (e.g., an email application) may be loaded on a first computing device as a first instance of the application, on a second computing device as a second instance of the application, and/or on other computing devices. It may be appreciated that the computing environment of the computing devices may be the same or different (e.g., an operating system of the first computing device, such as a desktop OS, may be different than an operating system of the second computing device, such as a mobile OS). An instance of the application may be associated with an application state (e.g., application data stored as settings or a file, such as a configuration file), which may be modified (e.g., an application may store a newly configured email account within the configuration file) and/or updated (e.g., updated during synchronization). The application state may correspond to a variety of information associated with the application, such as configuration settings (e.g., configured email accounts, email viewing preferences, email delivery preferences, etc.) and/or application files. The application state may be maintained by an instance of an application in various formats, such as a configuration file (e.g., an XML file), a hierarchical data structure, database entries, registry entries, and/or other formats. The application state may be formatted according to a schema, which may be identified by a schema version. For example, a first schema may provide for configuration settings, such as up to two email accounts, email delivery preferences, and email viewing preferences, to be stored according to a particular format within the application state. The schema of the application state may be updated to a second schema, which may allow for additional configuration settings, such as up to three email accounts, an email blacklist, and an email contact list, etc. The application state may provide for logical groupings of settings, which may be synchronized separately. For example, settings corresponding to a first email account may be logically grouped separate from settings corresponding to a second email account.

In one example, a first device may comprise a first instance of an application associated with a first application state (e.g., a first instance of a music application on a laptop device may store a first application state, such as music configuration settings, in a first configuration file), and a second device may comprise a second instance of the application associated with a second application state (e.g., a second instance of the music application on a tablet device may store a second application state, such as music configuration settings, in a second configuration file). The first instance, the second instance, and/or other instances of the application may be associated with a synchronization component.

At 104, a first application state update (e.g., synchronization data and/or instructions) may be received from the synchronization component at the second device (e.g., the tablet device). The first application state update may correspond to a modification to the first application state of the first instance of the application on the first device (e.g., the laptop device) being indicative of a modified first application state. For example, the first instance of the music application on the laptop device may modify application settings within the first configuration file (e.g., the first configuration file may be created within a synchronization folder; the first configuration file may be modified with a new music account; etc.). It may be advantageous to update the second instance of the music application on the tablet device to reflect the modified first application state of the first instance of the music application on the laptop device (e.g., the new music account may be automatically synchronized to the tablet device so that a user may not have to re-enter such information while on the tablet device).

At 106, the second application state of the second instance of the application on the second device may be identified. For example, the second instance of the music application on the tablet device may maintain the second configuration file within a synchronization folder (e.g., a local synchronization folder). At 108, the second application state may be updated using the first application state update to create a synchronized second application state. For example, the second configuration file maintained by the second instance of the music application on the tablet device may be updated to reflect the first configuration file (e.g., the modified first application state) maintained by the first instance of the music application on the laptop device to create the synchronized second application state (e.g., the new music account, added at the laptop device, may be added to the second configuration file at the tablet device). The second application state may be updated regardless of whether the second instance of the application is executing or not on the second device.

When updating the second application state, conflict resolution, version verification, and/or consistency verification may be performed. In one example, a version verification may be performed to determine whether a first application version of the first instance of the application corresponds to a second application version of the second instance. In one example, if the application versions do not correspond, then the second application state may not be updated (e.g., to avoid merging data that is stored in different data storage schema formats). In another example, if the application versions do not correspond, then the first application state update may be modified to conform to the second application version of the second instance.

In another example, a schema version verification may be performed (e.g., a schema version may correspond to a particular schema with which an application state may be formatted). For example, a first schema version associated with the modified first application state as indicated by the first application state update may be compared with a second schema version associated with the second application state. If the first schema version corresponds to the second schema version, then the second application state may be updated using the first application state update, otherwise the second application state may not be updated. That is, if the data storage schema formats are similar, then it may be safe to synchronize. Conversely, it may be unsafe to synchronize where the data storage schema formats are different. Schema version checking may be performed because an instance of an application may expect an application state to be formatted according to a particular schema format. For example, when the second instance of the music application reads the second application state, the second instance may expect the second application state to format music settings in a particular format as specified by the second schema version (e.g., the second application state may be formatted, such that up to two music accounts may be specified and eight different music playback settings may be specified). However, if the second application state is updated to reflect the modified first application state that may be formatted according to the first schema version that may be different than the second schema version (e.g., merely 1 music account may be specified and no music playback settings may be specified), then the second instance of the application may error when attempting to read the synchronized second application state because unexpected information may be encounter and/or expected information may be missing.

It may be appreciated that an instance of an application may modify/update a schema with which an application state is formatted. For example, a schema modification may be performed upon the second application state (e.g., the second instance of the music application may be updated to a new version that provides for a new schema with which the second application state may be formatted). Upon identifying the schema modification, the second application state may be reassigned from the second schema version to a third schema version. If the third schema version does not correspond to the first schema version associated with the modified first application state as indicated by the first application state update, then the second application state may not be updated. In another example, the third schema version assigned to the second application state may be compared to the first schema version assigned to the first application state to determine whether a conflict exists. By way merely of example and not limitation, if a conflict exists, then the third schema version and/or the first schema version may be modified to resolve the conflict based upon a preferred schema format. Thus, application data (e.g., preferred application data) may be synchronized to other devices (e.g., based upon evaluation and/or conflict resolution between schema versions). This may be applicable, for example, upon an initial installation of an application. In this way, schema version verification may be performed so that an instance of an application does not error from attempting to access a synchronized application state formatted according to an unexpected/unintelligible schema.

In another example, conflict resolution may be performed between the modified first application state, as indicated by the first application state update, and the second application state. For example, the second application state may comprise a password setting with a value “MyPassword”, which may have been created by a user of the second instance of the music application 2 months prior. The first application state update may indicate that the modified first application state may comprise a password setting with a value “MyNewPassword”, which may have been created by the user of the first instance of the music application 1 week prior. During the update of the second application state, conflict resolution may be performed between the two password settings based upon a last-to-write scheme, which may result in “MyPassword” being replaced with “MyNewPassword” because the value “MyNewPassword” may have been written more recently (e.g., “MyNewPassword” may be newer).

It may be appreciated that the application states of the first instance and the second instance may be synchronized back and forth between the first and second device one or more times. For example, a modification to the synchronized second application state resulting in a modified synchronized second application state may be detected (e.g., after updating the second application state using the first application state update, the resulting synchronized second application state may be modified, such as with a new password). In this way, a second application state update may be generated (e.g., synchronization data and/or instructions associated with the modifications to the synchronized second application state may be used to generate the second application state update). The second application state update may be sent to the synchronization component for synchronizing the modified first application state of the first instance of the application on the first device. In this way, the application states of the first and second instance may be synchronized.

It may be appreciated that application state synchronization may be facilitated between the first instance of the application of the first device, the second instance of the application on the second device, and/or one or more additional instances of the application on one or more additional devices, where conflict resolution between application settings and/or schema version consistency checking may be performed. In one example, an application state update (e.g., the second application state update) may be sent to the synchronization component for synchronizing a plurality of instances of the application on a plurality of devices. In another example, an installation, such as an initial installation, of a third instance of the application may be detected (e.g., on the first, second, and/or other device). Before execution of the third instance of the application (e.g., before a user attempts to interact with the third instance of the music application), a third application state associated with the third instance of the application may be created (e.g., created, updated, and/or populated) based upon a new application state update received from the synchronization component (e.g., the new application state update may correspond to a prior state of an instance of the application on a different device). In one example, the new application state update may be prefetched, and then cached on the device onto which the third instance of the application is to be installed. The cache may be updated based upon updates to an application state of an instance of the application on an originating/different device from which the new application state update was fetched. In another example the new application state update may be fetched upon detection of the installation of the third instance of the application, such that the new application state update may be applied to the third instance of the application to create the third application state (e.g., by the time installation of the third installation of the application is complete). In this way, application state synchronization may be facilitated between various devices to provide a user with a seamless and consistent transition from one device to another. At 110, the method ends.

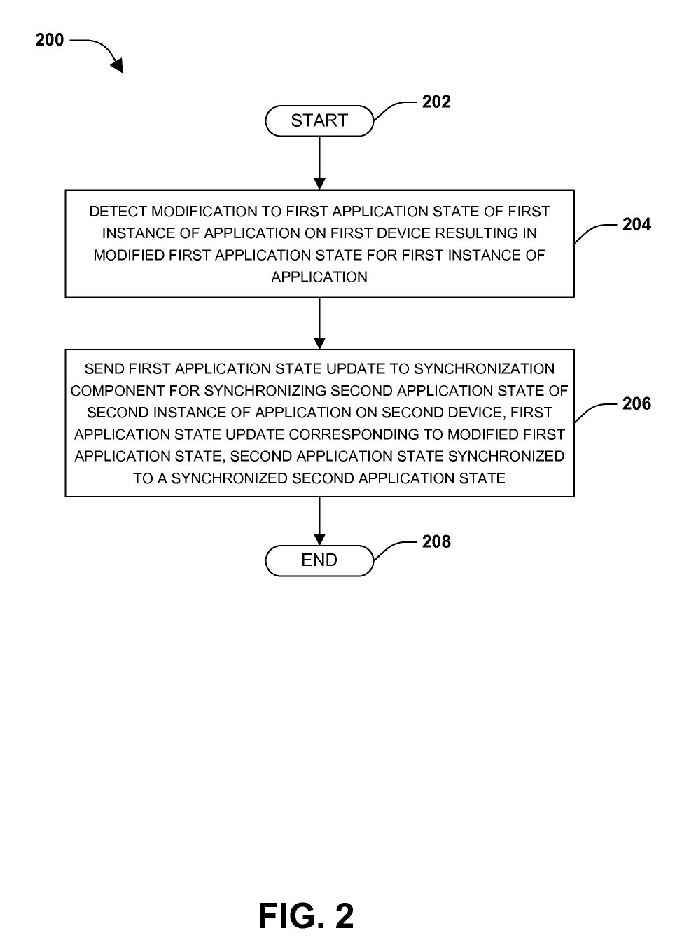

One embodiment of synchronizing application state is illustrated by an exemplary method 200 in FIG. 2. At 202, the method starts. In one example, a first device may comprise a first instance of an application associated with a first application state (e.g., a first instance of a music application on a laptop device may store a first application state, such as music configuration settings, in a first configuration file), and a second device may comprise a second instance of the application associated with a second application state (e.g., a second instance of the music application on a tablet device may store a second application state, such as music configuration settings, in a second configuration file). The first instance, the second instance, and/or other instances of the application may be associated with a synchronization component.

At 204, a modification to the first application state of the first instance of the application on the first device may be detected (e.g., the first instance of the music application may store a new user password setting within the first configuration file). The modification may result in a modified first application state for the first instance of the application. At 206, a first application state update may be sent to the synchronization component for synchronizing the second application state of the second instance of the application on the second device (e.g., the second configuration file maintained by the second instance of the music application may be updated with the new user password setting). The first application state update may correspond to the modified first application state (e.g., the first application state update may comprise the new user password setting, synchronization instructions, schema version, and/or other information). The second application state may be synchronized to a synchronized second application state based upon the first application state update.

In one example, a second application state update may be received, at the first device, from the synchronization component. The second application state update may correspond to a modification to the synchronized second application state of the second instance of the application on the second device (e.g., a new user name may have been added to the second configuration file maintained by the second instance that was updated using the first application state update). The modified first application state (on the first device) may be updated using the second application state update to create a synchronized third application state (e.g., the modified first application state may be updated with the new user name to create the synchronized third application state). In this way, application state synchronization may be facilitated between the first instance of the application and the second instance of the application. At 208, the method ends.

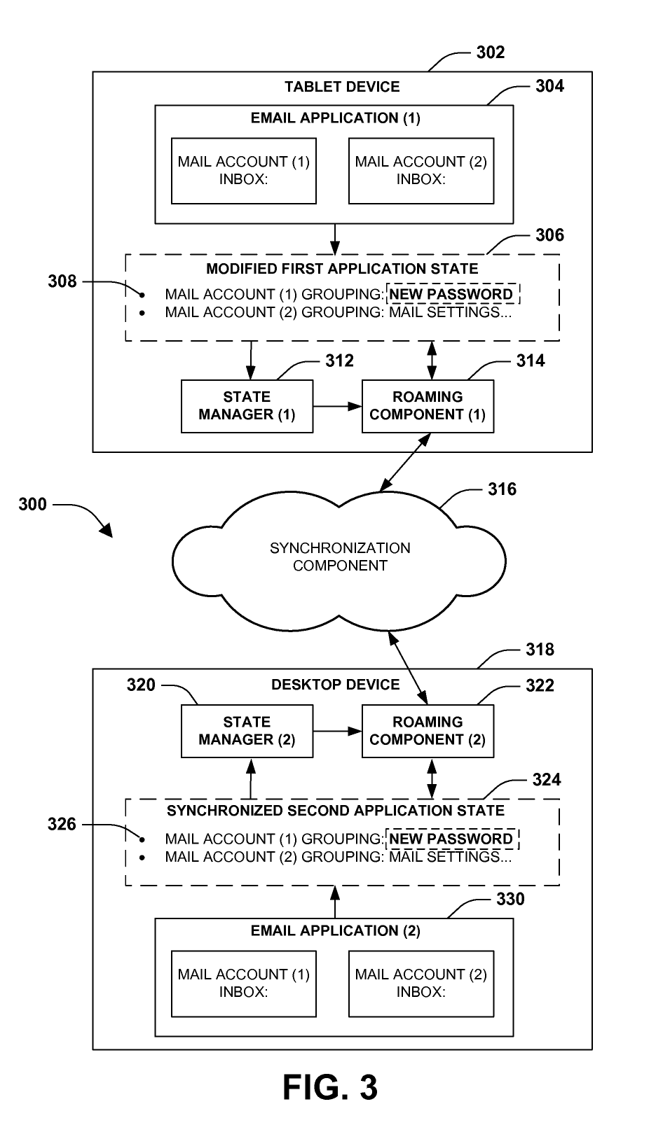

FIG. 3 illustrates an example of a system 300 configured for synchronizing application state. The system 300 may comprise a state manager (e.g., state manager (1) 312 and/or state manager (2) 320) and/or a roaming component (e.g., roaming component (1) 314 and/or roaming component (2) 322). The state manager may be configured to detect a modification to a first application state of a first instance of an application on a first device. The modification may result in a modified first application state for the first instance of the application. In one example, an email application (1) 304 (e.g., a first instance of an email application) on a tablet device 302 (e.g., a first device) may maintain email application settings within a first application state, not illustrated. For example, the email application (1) 304 may modify the first application state with a new password setting 308 associated with a first email account, resulting in a modified first application state 306 for the email application (1). In this way, the state manager (1) 312 may detect the modification.

The roaming component may be configured to send a first application state update to a synchronization component 316 for synchronizing a second application state of a second instance of the application on a second device. The first application state update may correspond to the modified first application state. In this way, the second application state may be synchronized to create a synchronized second application state. In one example, upon the state manager (1) 312 detecting the modification (e.g., the new password setting 308), the roaming component (1) 314 may create a first application state update. The first application state update may comprise the new password setting 308 and/or other information (e.g., a snapshot of the modified first application state 306, synchronization instructions, schema version, etc.). The roaming component (1) 314 may send the first application state update to the synchronization component 316 for updating a second application state of an email application (2) 330 (e.g., a second instance of the email application) on a desktop device 318 (e.g., a second device) to create the synchronized second application state 324. For example, the synchronized second application state 324 may be updated with a new password setting 326 based upon the first application state update. In this way, the application states of the email application (1) 304 and the email application (2) 330 may be synchronized with the new password setting, so that a user may seamlessly and consistently check email using the tablet device 302 and/or the desktop device 318 without having to manually reconfigure configuration settings, such as the new password.

The roaming component may be configured to resolve one or more conflicts between the modified first application state and the second application state. For example, the roaming component (2) 322 may determine that the first application state update specifies the new password setting 308, which may have been created 1 week ago. The roaming component (2) 322 may determine that the second application state may already comprise a password setting, which may have been created 1 month ago. The password settings may be compared to determine which password settings prevails. For example, the new password setting 308 may prevail (e.g., based upon a last-to-write scheme, a timestamp, and/or other filtering criteria), and thus the new password setting 326 may be added into the synchronized second application state 324.

When updating the second application state based upon the first application state update, the roaming component may be configured to verify schema version consistency between the modified first application state 306 and the second application state. For example, if a first schema version assigned to a first schema with which the modified first application state 306 is formatted corresponds to a second schema version assigned to a second schema with which the second application state is formatted, then second application state may be updated to create the synchronized second application state 324, otherwise the updating may not be performed to avoid errors that may occur if the email application (2) 330 encounters configuration settings stored in an unexpected format.

It may be appreciated that application state may be synchronized back and forth between the first instance of the application and the second instance of the application. For example, the roaming component (1) 314 may be configured to receive a second application state update from the synchronization component 316. The second application state update may correspond to a modification to the synchronized second application state 324 of the email application (2) 330 on the desktop device 318 (e.g., a user may have changed a user name for mail account (2) to a new user name while using the desktop device 318, which may have been detected by the state manager (2) 320 and/or used to generate the second application state update by the roaming component (2) 322). The roaming component (1) 314 may update the modified first application state 306 to create a synchronized third application state not illustrated. For example, the synchronized third application state may correspond to the modified first application state 306 updated with the new user name for the mail account (2).

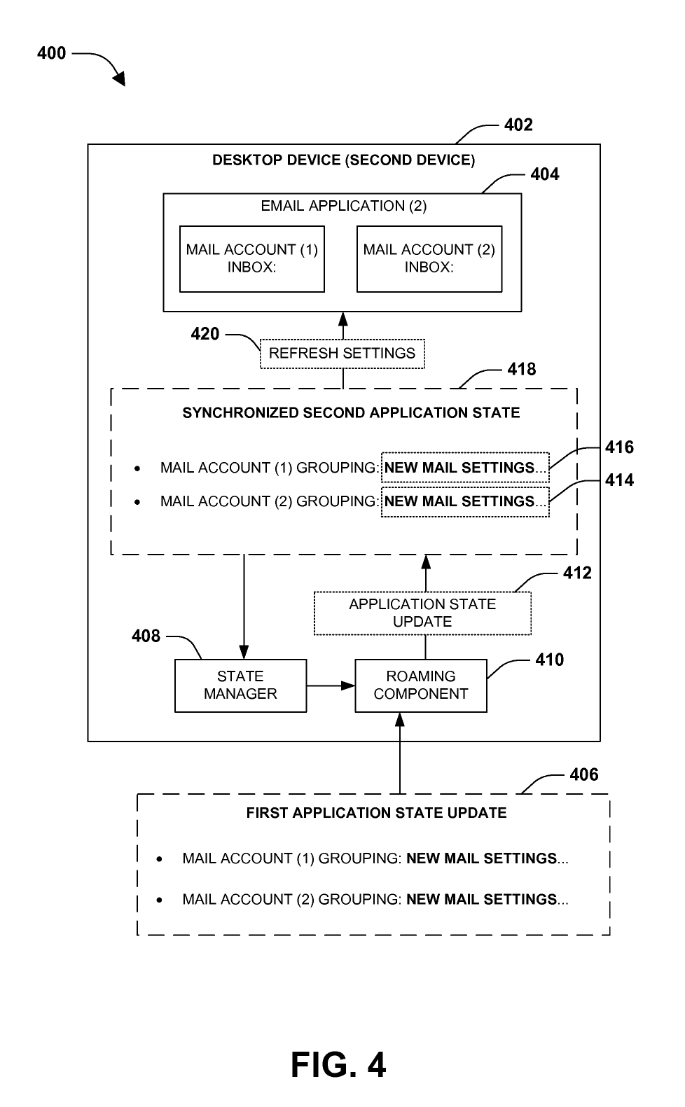

FIG. 4 illustrates an example 400 of synchronizing a second application state of an email application (2) 404 (e.g., a second instance of an email application) on a desktop device 402 (e.g., a second device) to create a synchronized second application state 418. The email application (2) 404 may allow a user to configure a first mail account and/or a second mail account. Settings associated with the first mail account may be stored within a first logical grouping, while settings associated with the second mail account may be stored within a second logical grouping. Such settings may be maintained by the email application (2) 404 within the second application state (e.g., second application state, not illustrated, may comprise old mail settings for mail account (1) logical grouping and/or old mail settings for mail account (2) logical grouping).

A state manager 408 may be configured to detect modifications to the second application state (e.g., a change in user password). A roaming component 410 may be configured to receive a first application state update 406. The first application state update 406 may correspond to a modified first application state associated with an email application (1) (e.g., a first instance of the email application) on a tablet device (e.g., a first device), not illustrated. For example, the first application state update 406 may comprise new mail settings associated with mail account (1) logical grouping and/or new mail settings associated with mail account (2) logical grouping (e.g., a user may have changed a password associated with both mail accounts using the email application (1) loaded on the tablet device).

The roaming component 410 may update (e.g., application state update 412) the second application state using the first application state update 406 to create the synchronized second application state 418. For example, the mail account (1) logical grouping may be updated with new mail settings 416 (e.g., originating from the first application state update 406) and/or the mail account (2) logical grouping may be updated with new mail settings 414 (e.g., originating from the first application state update 406). For example, the logical groupings may be separately updated, such that none, one, or both logical groupings may be updated. The roaming component 410 may notify (e.g., refresh settings 420) the email application (2) 404 to refresh settings based upon the update.

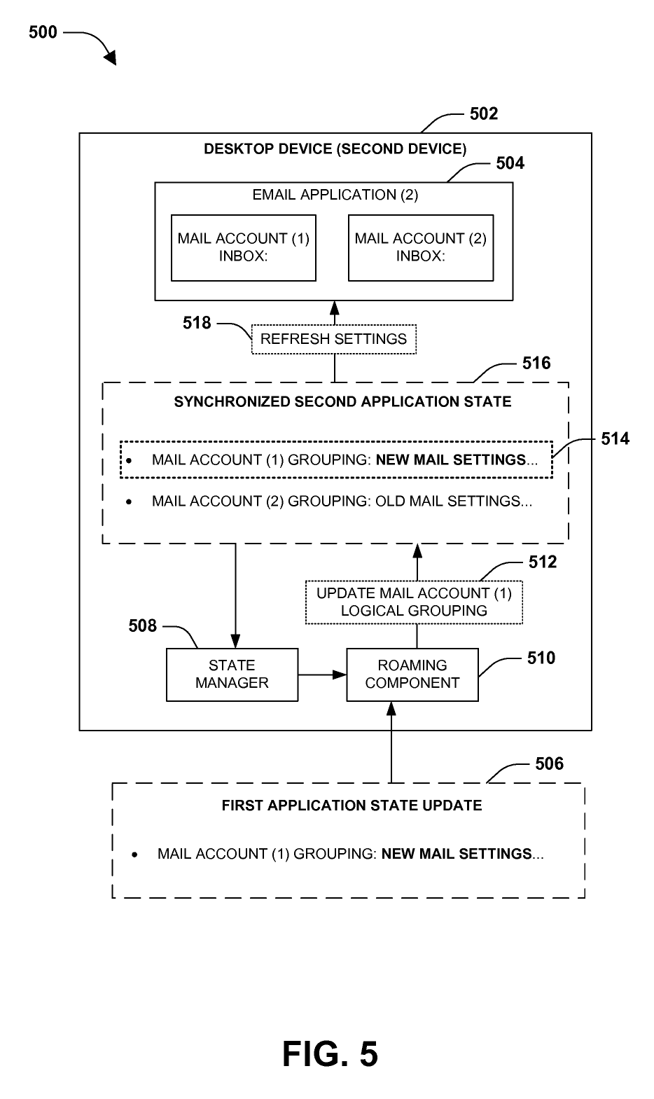

FIG. 5 illustrates an example 500 of synchronizing a mail account (1) logical grouping within a second application state of an email application (2) 504 (e.g., a second instance of an email application) on a desktop device 502 (e.g., a second device) to create a synchronized second application state 516. The email application (2) 504 may allow a user to configure a first mail account and/or a second mail account. Settings associated with the first mail account may be stored within a first logical grouping, while settings associated with the second mail account may be stored within a second logical grouping. Such settings may be maintained by the email application (2) 504 within the second application state (e.g., second application state, not illustrated, may comprise old mail settings for mail account (1) logical grouping and/or old mail settings for mail account (2) logical grouping).

A state manager 508 may be configured to detect modifications to the second application state (e.g., a change in user password). A roaming component 510 may be configured to receive a first application state update 506. The first application state update 506 may correspond to a modified first application state associated with an email application (1) (e.g., a first instance of the email application) on a tablet device (e.g., a first device), not illustrated. For example, the first application state update 506 may comprise new mail settings associated with mail account (1) logical grouping (e.g., a user may have change a mail viewing preference for mail account (1) using the email application (1) loaded on the tablet device).

The roaming component 510 may update 512 mail account (1) logical grouping within the second application state using the first application state update 506. For example, the mail account (1) logical grouping may be updated with new mail settings 514 (e.g., originating from the first application state update 506) to create the synchronized second application state 516. In one example, the mail account (2) logical grouping may not be updated for various reasons (e.g., the first application state update 506 may lack adequate update information for mail account (2), a consistency and/or conflict may exist between update information for mail account (2) within the first application state update 506, etc.). The roaming component 510 may notify (e.g., refresh settings 518) the email application (2) 504 to refresh settings for the mail account (1) based upon the update.

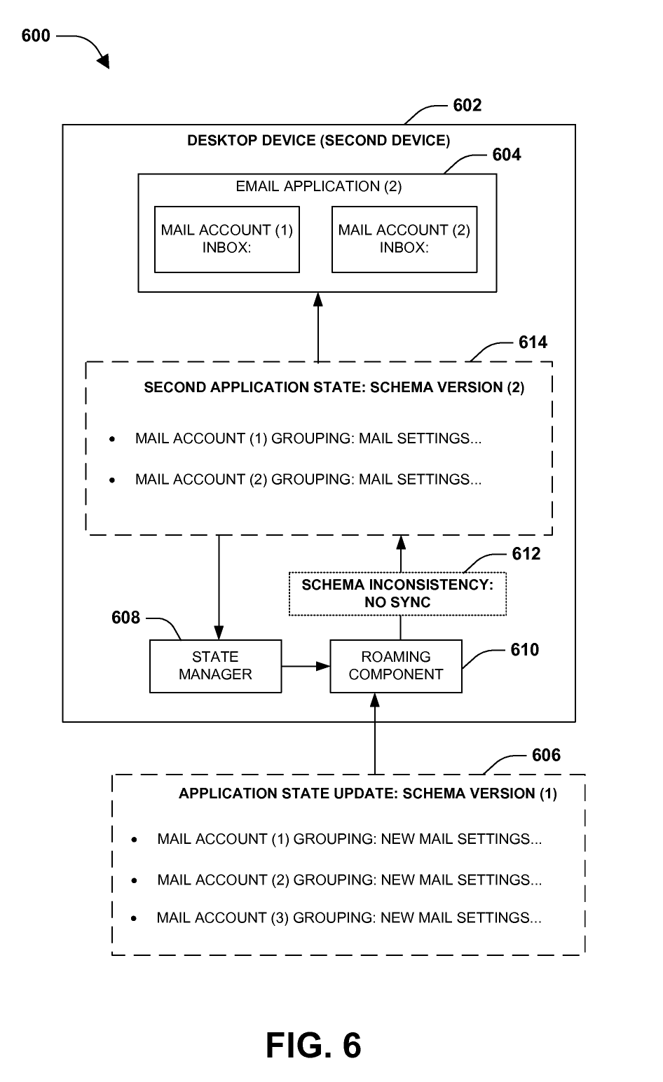

FIG. 6 illustrates an example 600 of refraining from synchronizing a second application state 614 of an email application (2) 604 (e.g., a second instance of an email application) on a desktop device 602 (e.g., a second device) based upon a detected schema version inconsistency 612. The email application (2) 604 may allow a user to configure a first mail account and/or a second mail account. Settings associated with the first mail account may be stored within a first logical grouping, while settings associated with the second mail account may be stored within a second logical grouping. Such settings may be maintained by the email application (2) 604 within the second application state 614 based upon a second schema identified by a schema version (2). For example, the second schema may provide for up to two mail accounts, where a user name and password may be specified in separate settings (e.g., a user name setting and a password setting).

A state manager 608 may be configured to detect modifications to the second application state 608. A roaming component 610 may be configured to receive a first application state update 606. The first application state update 606 may correspond to a modified first application state associated with an email application (1) (e.g., a first instance of the email application) on a tablet device (e.g., a first device), not illustrated. For example, the first application state update 606 may comprise new mail settings associated with mail account (1) logical grouping, new mail settings associated with mail account (2) logical group, and new mail settings associated with mail account (3) logical group. In one example, the first application state update 606 may specify that the modified first application state may have been formatted according to a first schema identified by a schema version (1). For example, the first schema may provide up to three mail accounts, where a user name and password may be specified within a single setting (e.g., a username/password setting).

The roaming component 610 may determine that the schema version (2) and the schema version (1) do not match (e.g., the first schema provides for an extra mail account and stores usernames and passwords differently than the second schema). Accordingly, the roaming component 610 may refrain from synchronizing the second application state 614 based upon the detected schema version inconsistency 612. Otherwise, the mail application (2) 604 may error when attempting to read a synchronized second application state formatted in a schema different than the second schema expected by the mail application (2) 604.

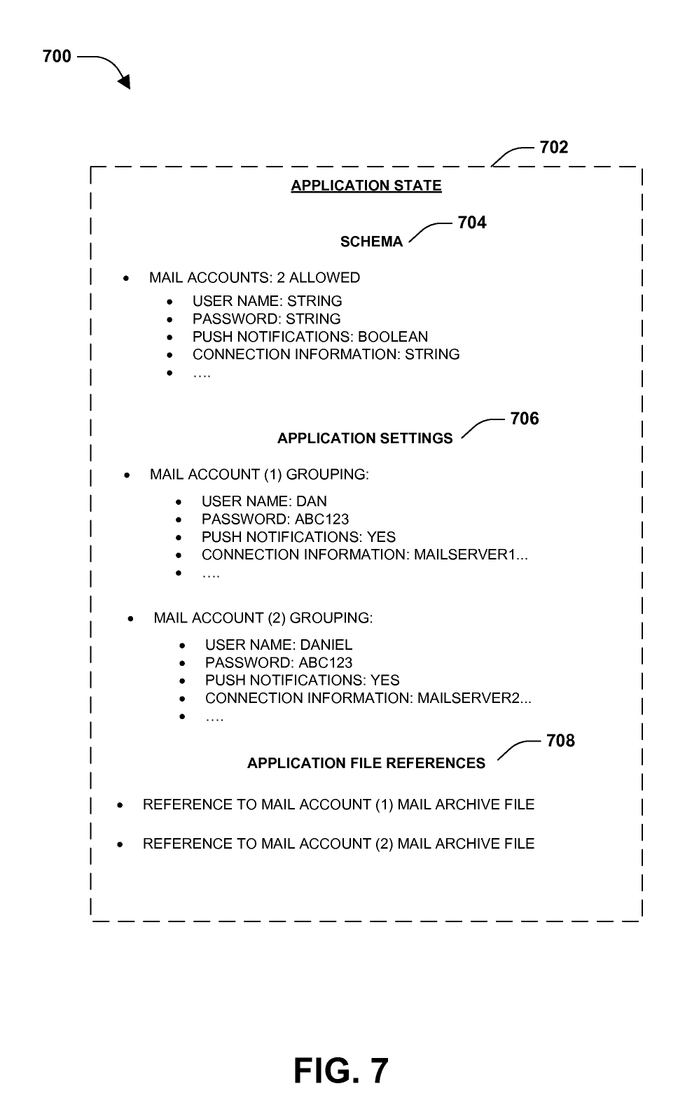

FIG. 7 illustrates an example 700 of an application state 702. It may be appreciated that application state 702 is merely an example of an application state, and that various other information may be comprised within and/or excluded from an application state. In one example, the application state 702 may be formatted according to a schema 704. The schema 704 may specify that up to two mail accounts may be configured for an email application associated with the application state 702. The schema 704 may specify that an email account may be described using a user name setting, a password setting, a push notifications setting, a connection information setting, and/or other settings, which may be specified in various data formats, such as strings, Booleans, etc.

The application state 702 may comprise applications settings 706, which may be logically grouped. For example, a mail account logical grouping (1) and/or a mail account logical grouping (2) may be specified according to the schema 704. In one example, other information, such as references to application files 708, may be specified within the application state 702 (e.g., references to mail archive files associated with the first and second mail account). In this way, the email application may store, retrieve, and/or modify information, such as mail account settings, within the application state 702 without foisting complex synchronization and/or locking API's on developers.

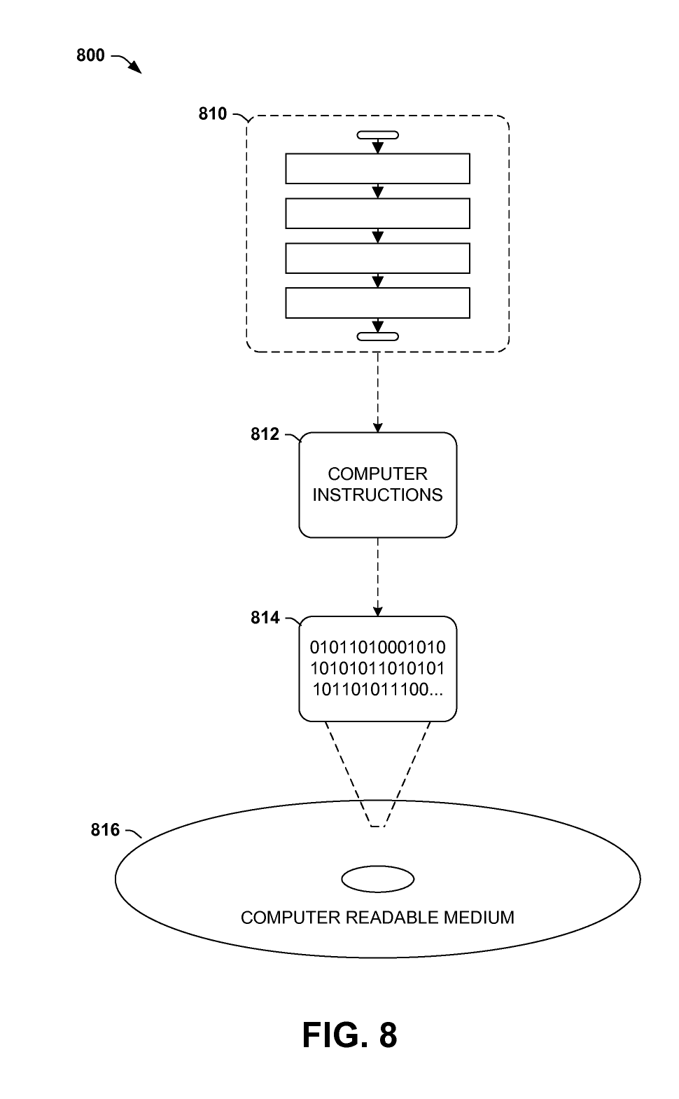

Still another embodiment involves a computer-readable medium comprising processor-executable instructions configured to implement one or more of the techniques presented herein. An exemplary computer-readable medium that may be devised in these ways is illustrated in FIG. 8, wherein the implementation 800 comprises a computer-readable medium 816 (e.g., a CD-R, DVD-R, or a platter of a hard disk drive), on which is encoded computer-readable data 814. This computer-readable data 814 in turn comprises a set of computer instructions 812 configured to operate according to one or more of the principles set forth herein. In one such embodiment 800, the processor-executable computer instructions 812 may be configured to perform a method 810, such as at least some of the exemplary method 100 of FIG. 1 and/or at least some of exemplary method 200 of FIG. 2, for example. In another such embodiment, the processor-executable instructions 812 may be configured to implement a system, such as at least some of the exemplary system 300 of FIG. 3, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

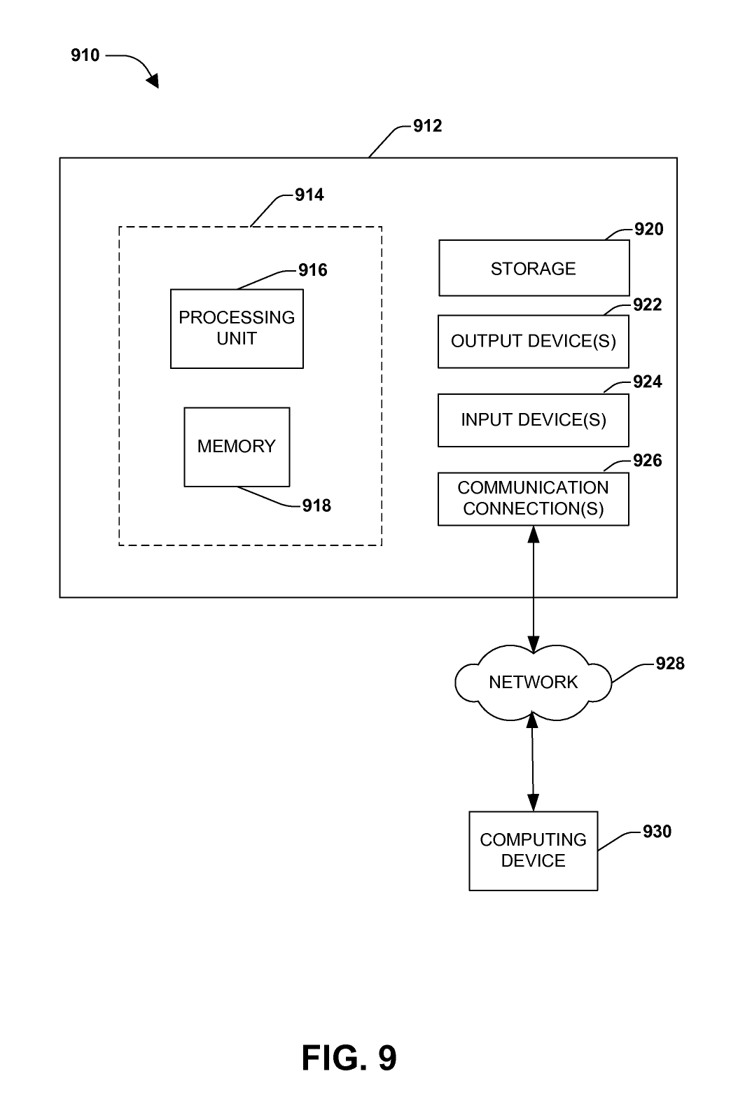

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for synchronizing application state, comprising:
receiving, at a second device, a first application state update from a synchronization component, the first application state update corresponding to a modification to a first application state of a first instance of an application on a first device and being indicative of a modified first application state;
identifying a second application state of a second instance of the application on the second device; and
updating the second application state using the first application state update to create a synchronized second application state.

2. The method of claim 1, comprising:
detecting a modification to the synchronized second application state resulting in a modified synchronized second application state; and
sending a second application state update to the synchronization component for synchronizing the modified first application state of the first instance of the application on the first device, the second application state update corresponding to the modified synchronized second application state.

3. The method of claim 1, the updating comprising:
determining whether a first schema version associated with the modified first application state as indicated by the first application state update corresponds to a second schema version associated with the second application state; and
if the first schema version corresponds to the second schema version, then updating the second application state using the first application state update, otherwise refraining from updating the second application state.

4. The method of claim 3, comprising:
identifying a schema modification to the second application state; and
reassigning the second application state from the second schema version to a third schema version.

5. The method of claim 4, comprising:
upon determining the third schema version does not correspond to the first schema version, refraining from updating the second application state.

6. The method of claim 1, the second application state corresponding to at least one of: application settings and application files.

7. The method of claim 1, comprising:
facilitating application state synchronization between the first instance of the application on the first device, the second instance of the application on the second device, and one or more additional instances of the application on one or more additional devices, the facilitating comprising performing conflict resolution between application settings and performing schema version consistency checking.

8. The method of claim 1, the second application state and the modified first application state comprising at least one of: a first logical grouping of application data and a second logical group of application data.

9. The method of claim 4, the updating comprising:
comparing the third schema version assigned to the second application state with the first schema version assigned to the first application state to determine whether a conflict exists; and
if a conflict exists, then modifying at least one of the third schema version and the first schema version to resolve the conflict based upon a preferred schema format.

10. The method of claim 1, comprising:
detecting an installation of a third instance of the application; and
creating, before a first execution of the third instance of the application, a third application state associated with the third instance of the application based upon a new application state update received from the synchronization component.

11. The method of claim 1, the updating comprising:
determining a conflict exists between the modified first application state, as indicated by the first application state update, and the second application state; and
resolving the conflict.

12. The method of claim 11, the resolving the conflict comprising:
resolving the conflict based upon a last-to-write scheme.

13. The method of claim 2, the sending a second application state update comprising:
sending the second application state update to the synchronization component for synchronizing a plurality of instances of the application on a plurality of devices.

14. The method of claim 1, the first device comprising a first computing environment and the second device comprising a second computing environment different from the first computing environment.

15. The method of claim 1, the updating comprising:
updating the second application state when the second instance of the application is not executing.

16. A system for synchronizing application state, comprising:
a state manager configured to:
detect a modification to a first application state of a first instance of an application on a first device resulting in a modified first application state for the first instance of the application; and
a roaming component configured to:
upon the state manager detecting the modification, send a first application state update to a synchronization component for synchronizing a second application state of a second instance of the application on a second device, the first application state update corresponding to the modified first application state, the second application state synchronized to a synchronized second application state.

17. The system of claim 16, the roaming component configured to:
receive a second application state update from the synchronization component, the second application state update corresponding to a modification to the synchronized second application state of the second instance of the application on the second device; and
update the modified first application state using the second application state update to create a synchronized third application state.

18. The system of claim 16, the roaming component configured to:
resolve one or more conflicts between the modified first application state and the second application state; and
verify schema version consistency between the modified first application state and the second application state.

19. A method for synchronizing application state, comprising:
detecting a modification to a first application state of a first instance of an application on a first device resulting in a modified first application state for the first instance of the application; and
sending a first application state update to a synchronization component for synchronizing a second application state of a second instance of the application on a second device, the first application state update corresponding to the modified first application state, the second application state synchronized to a synchronized second application state.

20. The method of claim 19, comprising:
receiving a second application state update from the synchronization component, the second application state update corresponding to a modification to the synchronized second application state of the second instance of the application on the second device; and
updating the modified first application state using the second application state update to create a synchronized third application state.
